(19) United States
(12) Patent Application Publication
(10) Pub. No.: US 2025/0285478 A1
(43) Pub. Date: Sep. 11, 2025

(54) DYNAMIC VEHICLE RENDERING SYSTEM

(71) Applicant: Rivian IP Holdings, LLC, Irvine, CA (US)

(72) Inventors: Eduardo Martinez REYES, San Jose, CA (US); Nick Adam MALACHOWSKI, Irvine, CA (US); Julliana Jean-Young CHO, Irvine, CA (US); Eric Ross Baker WOOD, Menlo Park, CA (US); Raymond Ruey-Shih CHOU, Moss Beach, CA (US); Karteek Kumar MEKALA, Belmont, CA (US); Andreas POSER, Irvine, CA (US); Katelyn Michele KEUCH, Raleigh, NC (US); Steven Morton GOODIN, Sacramento, CA (US); James William ROBBINS, Long Beach, CA (US); James Ronald PROVOST, Toronto (CA)

(21) Appl. No.: 19/070,214

(22) Filed: Mar. 4, 2025

Related U.S. Application Data
(60) Provisional application No. 63/561,674, filed on Mar. 5, 2024.

(51) Int. Cl. G07C 5/08; G06T 13/20; G06T 15/02; G06T 17/00; G06T 19/20

(52) U.S. Cl. CPC G07C 5/0825; G06T 13/20; G06T 15/02; G06T 17/00; G06T 19/20; G06T 2219/2012; G06T 2219/2024

(57) ABSTRACT

A vehicle includes a chassis, a vehicle body mounted to the chassis, a display device within the vehicle body, and a control system coupled to the chassis and the display device. The control system is configured to detect a change to at least one of the chassis or the vehicle body. The control system is further configured to generate a three-dimensional scene including a representation of a three-dimensional model the vehicle, the three-dimensional scene corresponding to the change. The control system renders the three-dimensional scene to obtain an image and outputs the image on the display device. The image may be rendered using cel shading. The three-dimensional scene may further correspond to an environment of the vehicle such as weather, landscape, and time of day.

### RELATED APPLICATION

This application claims the benefit of U.S. Provisional Application Ser. No. 63/561,674 filed Mar. 5, 2024, and entitled DYNAMIC VEHICLE RENDERING SYSTEM, which is hereby incorporated herein by reference in its entirety.

### INTRODUCTION

The present disclosure relates to a system for dynamically rendering a vehicle.

### SUMMARY

The present disclosure describes an approach for performing dynamic renderings of a vehicle for display on a display device of the vehicle. In one aspect, a vehicle includes a chassis, a vehicle body mounted to the chassis, a display device within the vehicle body, and a control system coupled to the chassis and the display device. The control system is configured to detect a change to at least one of the chassis or the vehicle body. The control system is further configured to generate a three-dimensional scene including a representation of a three-dimensional model the vehicle, the three-dimensional scene corresponding to the change. The control system renders the three-dimensional scene to obtain an image and outputs the image on the display device.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating a system for dynamically rendering a vehicle in accordance with certain embodiments.

FIG. 4 is a process flow diagram of a method for dynamically rendering a vehicle in accordance with certain embodiments.

FIG. 5A is an example dynamic rendering of a vehicle in accordance with certain embodiments.

FIG. 5B is another example dynamic rendering of a vehicle in accordance with certain embodiments.

FIG. 5C illustrates objects associated with a model of a vehicle to facilitate rendering in accordance with certain embodiments.

FIGS. 6A to 6D illustrate transitions between scene renderings for different drive modes in accordance with certain embodiments.

### DETAILED DESCRIPTION

Images are generated for display on a display device of a vehicle. The images include representations of the vehicle corresponding to a configuration of the vehicle, such as paint color, wheel type, and the like. In addition, the vehicle state may be represented in the image. The vehicle state may include externally visible attributes, such as the current ride height, the state of one or more doors, port covers, liftgates, tailgates, etc. The vehicle state may include a currently selected drive mode of the vehicle. The image may be obtained by rendering a scene including a model of the vehicle in a landscape corresponding to the vehicle state, such as the current drive mode. The scene may further include props selected according to the vehicle state. The vehicle and props may be animated. The scene and/or props may be selected according to an environment of the vehicle, such as a landscape, time of day, and/or weather.

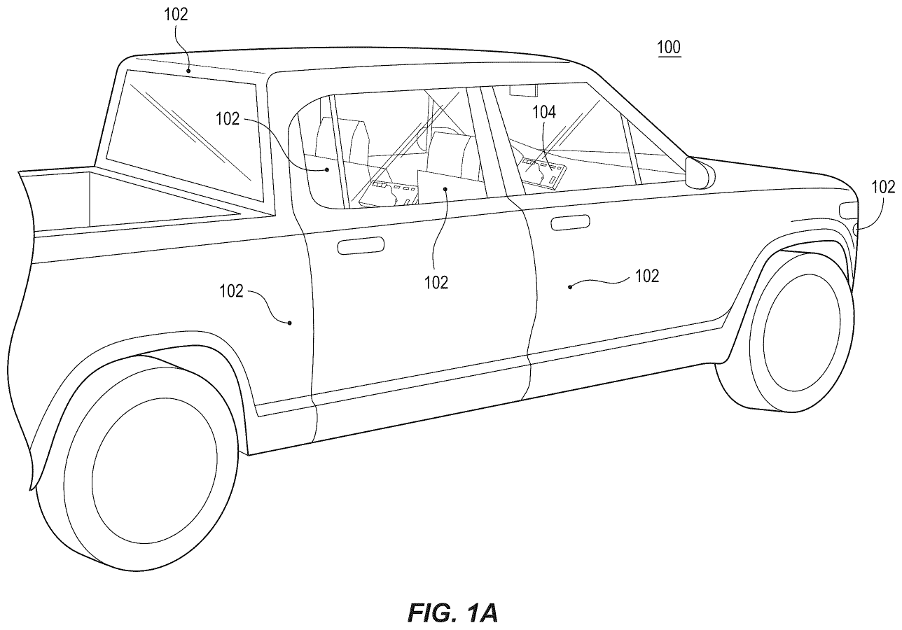

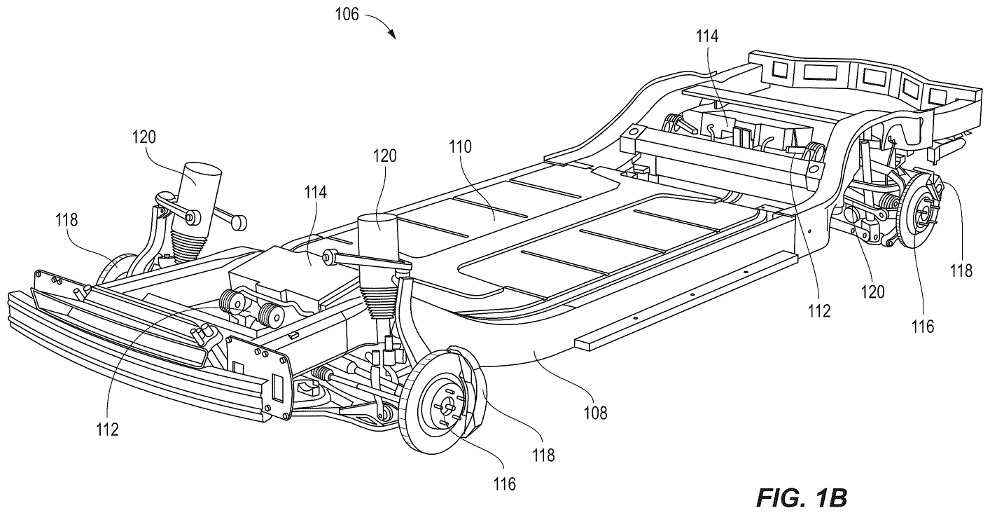

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver. The vehicle 100 further includes a plurality of road wheels 105, such as four, that are driven to propel the vehicle 100 over a surface.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle 100 (i.e., unibody construction). The body of the vehicle 100 may include external body panels, windows, doors, port covers, tailgates, liftgates, etc.

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more power modules 114, such as power electronics for each drive unit 112 or pair of drive units 112. The power modules 114 may include inverters configured to convert direct current (DC) from the battery 110 into alternating current (AC) supplied to the motors of the drive units 112. The power modules 114 further facilitate operation of the motors of the drive units as generators to provide regenerative braking. The power modules 114 further facilitate the transfer of regenerative current to the battery 110.

The drive units 112 are coupled to two or more hubs 116 to which road wheels 105 may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, an internal combustion engine (ICE) vehicle or hybrid-electric vehicle may also benefit from the approach described herein.

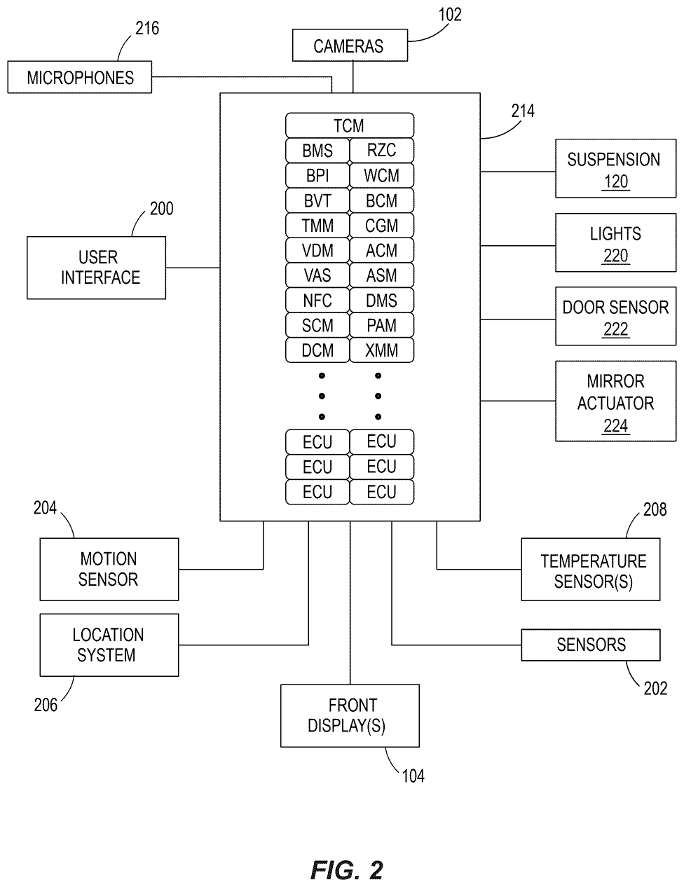

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114.

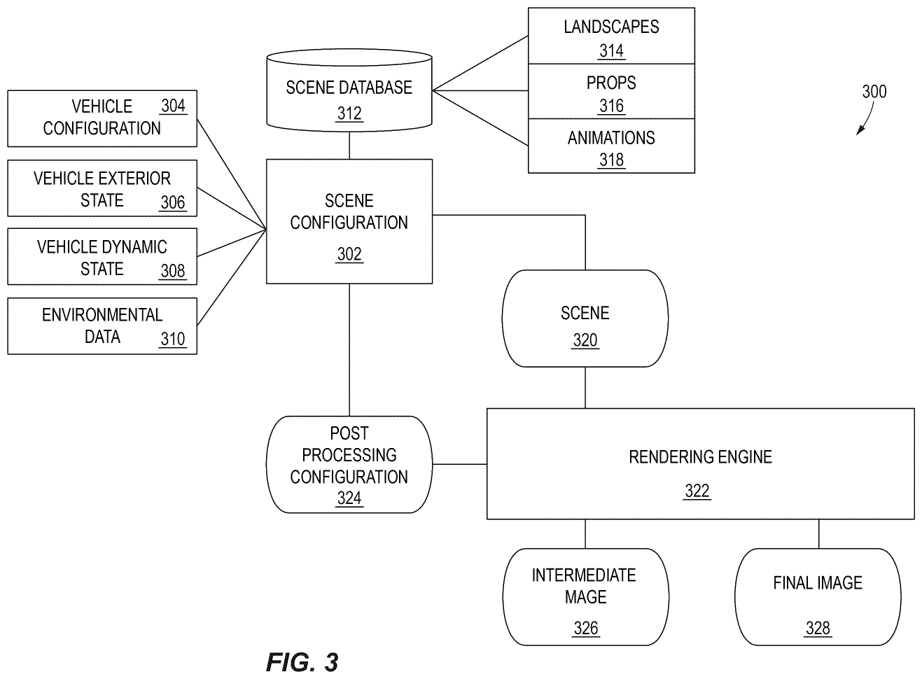

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6F. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The control system 214 may be coupled to one or more other components of the vehicle 100 in order to control the components or determine the state of the one or more other components. For example, the control system 214 may be coupled to the suspension 120 in order to determine the state thereof or to control the configuration thereof (e.g., stiffness, ride height, damping, etc.). The control system 214 may be coupled to external lights 220 of the vehicle, such as headlights, taillights, one or more light bars, tracer lights, or other lights. The control system 214 may be coupled to one or more door sensors 222 configured to sense a state of doors, liftgates, tailgates, bed cover, hood, charge port cover, gear tunnel cover, or other access panels. The control system 214 may be coupled to mirror actuators 224 for controlling the orientation of sideview mirrors. The illustrated components 116, 220, 222, 224 are exemplary only. Any component of the vehicle that can change state may be coupled to the control system 214 such that the control system 214 can one or both of control the state of the component and sense the state of the component.

Referring to FIG. 3, the illustrated system 300 may be implemented by the control system 214 or a separate computing device in the vehicle 100 that is connected to the control system 214. In other embodiments, the system 300 may be implemented remotely from the vehicle 100 with inputs to the system 300 received from the control system 214 and images resulting from the system 300 being transmitted to the control system 214 for display.

The system 300 may include a scene configurator 302. The scene configurator generates a dynamic three-dimensional scene that is used to dynamically render an image of a three-dimensional model of the vehicle 100 for output, such as on one or more of the front displays 104.

The scene configurator 302 may take as inputs some or all of a vehicle configuration 304, a vehicle exterior state 306, a vehicle dynamic state 308, and environmental data 310.

The vehicle configuration 304 may include attributes of the vehicle 100 at the time of manufacture or as a result of modifications to the vehicle 100. The attributes may include a body style (truck or sport utility vehicle), model name (e.g., name used in offering the vehicle 100 for sale), a paint color, window tinting color, model of rims, model of tires, badging, description of decorative trim, model of truck bed cover, or any other visually discernable attribute of the vehicle 100.

The vehicle exterior state 306 indicates the state of one or more components of the vehicle that are capable of changing state and are either on the exterior of the vehicle 100 or visible from outside of the vehicle 100. For example, a non-exclusive list of components that may be described by the vehicle exterior state 306 may include:
A state of the suspensions 120 of the vehicle (e.g., current ride height, target ride height of a commanded change in ride height, or compression state of the suspension 120 for each wheel 105).
A state of lights 220 (e.g., on, off, or at some intermediate intensity, or color (where tunable)).
A state of a door (open, closed, or at some intermediate position)
A state of a liftgate, tailgate, rear door, or bed cover (open, closed, or at some intermediate position)
A state of a charge port cover or filler port cover (open, closed, or at some intermediate position)
A state of mirrors (e.g., folded in or out)
Whether an accessory is connected to the vehicle (a trailer, camper tent, etc.) and a model, style, or other attribute of the accessory. Accessories may be detected by detecting connection to an electrical port of the vehicle 100 (such as for a trailer), detecting the accessory or a portion of the accessory (such as a camper tent or a ladder of a camper tent) in an output of a camera 102 of the vehicle 100, detecting wireless signals emitted by the accessory, or some other approach.

The vehicle dynamic state 308 indicates attributes of the vehicle describing the dynamic behavior of the vehicle. For example, the vehicle modes may include a plurality of drive modes. The dynamic state 308 may include a current drive mode of the plurality of drive modes that the control system 214 is currently implementing. Each drive mode of the plurality of drive modes defines a different configuration of the vehicle 100 selected to accommodate the manner in which the vehicle 100 is driven and/or the surface on which the vehicle 100 is driven. A vehicle 100 may also tow a trailer and may include a drive mode configured to facilitate such use. Each drive mode may be defined as including a collection of values for attributes that are configurable by the control system 214, such as by the Vehicle Dynamics Module (VDM) ECU of the control system 214.

The attributes of a drive mode may include attributes of the suspensions 120, such as suspension stiffness, suspension damping, and ride height (which may also be part of the vehicle exterior state 306). The values for these attributes may be the same for all of the suspensions 120 or may be different, such as different for front and rear suspensions 120. The values for some attributes may be constrained to be the same for all suspensions 120, such as ride height.

The attributes of a drive mode may include an accelerator response. The accelerator response defines the desired acceleration (positive or negative), change in torque output by one or more motors, change in current supplied to one or more motors, or some other metric. The accelerator response may be a function of a position, or change in position, of an accelerator pedal of the vehicle 100. The accelerator response may be a function of the current velocity of the vehicle. The accelerator response may include a discrete set of accelerator responses, such as an accelerator response for each drive mode and/or for groups of two or more drive modes.

The attributes of a drive mode may include a braking response. The braking response defines a desired deceleration, braking fluid pressure, or other metric of braking performance to be achieved for a given position, or change in position, of a brake pedal of the vehicle 100. The braking response may be a function of the current velocity of the vehicle. The braking response may include a discrete set of braking responses, such as a braking response for each drive mode and/or for groups of two or more drive modes.

The attributes of a drive mode may include a regenerative braking behavior. The regenerative braking behavior may define an amount of power generation to be performed in response to releasing of the accelerator pedal, depressing of the brake pedal, or other event. The regenerative braking behavior may be a function of the velocity of the vehicle 100. The regenerative braking behavior may include a discrete set of regenerative braking behaviors, such as a regenerative braking behavior for each drive mode and/or for groups of two or more drive modes.

The attributes of a drive mode may include a steering response. The steering response defines an angle or change in angle of two or four wheels of the vehicle 100 for a given angle or change in angle of a steering wheel, yoke, lever, or other interface. The steering response may be a function of the velocity of the vehicle 100. The steering response may include a discrete set of steering responses, such as a steering response for each drive mode and/or for groups of two or more drive modes.

The attributes of a drive mode may include a torque distribution. The torque distribution may define a ratio of torque applied to the front wheels 105 relative to the torque applied to the rear wheels 105. For example, in an energy saving mode, the drive unit 112 driving the front wheels may contribute zero torque or less than 10 percent of the torque supplied by the rear wheels, or vice versa. The torque distribution may include a discrete set of torque distributions, such as a torque distribution for each drive mode and/or for groups of two or more drive modes.

The attributes of a drive mode may include traction control behavior. The traction control behavior may define the function of a traction control system configured to prevent slipping of the wheels of the vehicle 100. The traction control behavior may define how aggressively this function is performed or whether the function of the traction control system is disabled. The traction control behavior may include a discrete set of traction control behaviors, such as a traction control behavior for each drive mode and/or for groups of two or more drive modes.

The attributes of a drive mode may include stability control behavior. The stability control behavior may define the function of a stability control system configured to prevent the vehicle 100 from achieving states where rollover is likely. The stability control system may do so by overriding steering and accelerator pedal inputs of a driver in response to detected longitudinal acceleration, lateral acceleration, or rotational acceleration in some or all of the pitch, yaw, and roll directions. The stability control behavior may define how aggressively this function is performed or whether the function of the stability control system is disabled. The stability control behavior may include a discrete set of stability control behaviors, such as a stability control behavior for each drive mode and/or for groups of two or more drive modes.

The drive modes may include as non-limiting examples:
An on-road mode configured for driving on paved roads under dry conditions.
An off-road mode configured for driving on dirt, sand, gravel, etc.
A rock crawling mode configured for driving over large obstacles at slow speeds.
A sand mode configured for driving in sand.
A rally mode configured for high-speed driving around tight turns, possibly with limited traction, with relatively large amounts of permitted oversteer.
A drift mode permitting large amounts of oversteer and intentional release of traction of the rear wheels.
A snow and ice mode configured for avoiding loss of traction on snow and ice.
A towing mode (or towing sub-mode of any of the above-described modes) configured for towing a trailer.

The control system 214 may define other modes of operation other than drive modes, such as a camping mode in which the vehicle is configured to facilitate camping using a tent or camper mounted to the vehicle 100.

The environmental data 310 describes the current environment of the vehicle 100. The current environment may include the time of day, the weather, or one or more descriptors of a landscape in which the vehicle is located. For example, whether the current location, is on or near the beach, in the mountains, in a rural environment, in a city, in a desert, in a forest. The environment may be determined using map data, e.g., retrieving a description of a landscape corresponding to the current location of the vehicle. The landscape may be general or specific to the actual location.

The scene configurator 302 may further host or access a scene database 312. The scene database 312 stores a plurality of landscapes 314. Each landscape 314 may include a three-dimensional model of a landscape. The three-dimensional model may include a representation of a surface, such as a road, trail, beach, forest, or the like. The representation of the surface may define three-dimensional contours and textures for the surface. The scene may include representations of fixed objects or features of a landscape, such as trees, buildings, rocks, fences, wind turbines, or any other natural or artificial object.

The scene database 312 may include props 316. Prop 316 may be models of objects or features that can be combined with a landscape to compose a scene. The props 316 may include models of any natural or artificial object. For example, props 316 may include models of clouds, the sun, the moon, stars, trees, rocks, birds, wildlife, livestock, or the like. The props 316 may include models of recreational objects (tents, camping chairs, campfire, etc.), other vehicles, road furniture (signs, guard rails, etc.), buildings, wind turbines, or any other artificial object that may be encountered when driving or used in association with a vehicle.

The props 316 may include a model of the vehicle 100. The props 316 may include a model of the vehicle 100 having the same manufacturer model designation as the vehicle 100. The model may then be modified according to the vehicle configuration 304 to have attributes of the vehicle 100 defined by the vehicle configuration 304. Alternatively, the props 316 may include a model of the vehicle 100 that already has the attributes of the vehicle 100 as described above with respect to the vehicle configuration 304.

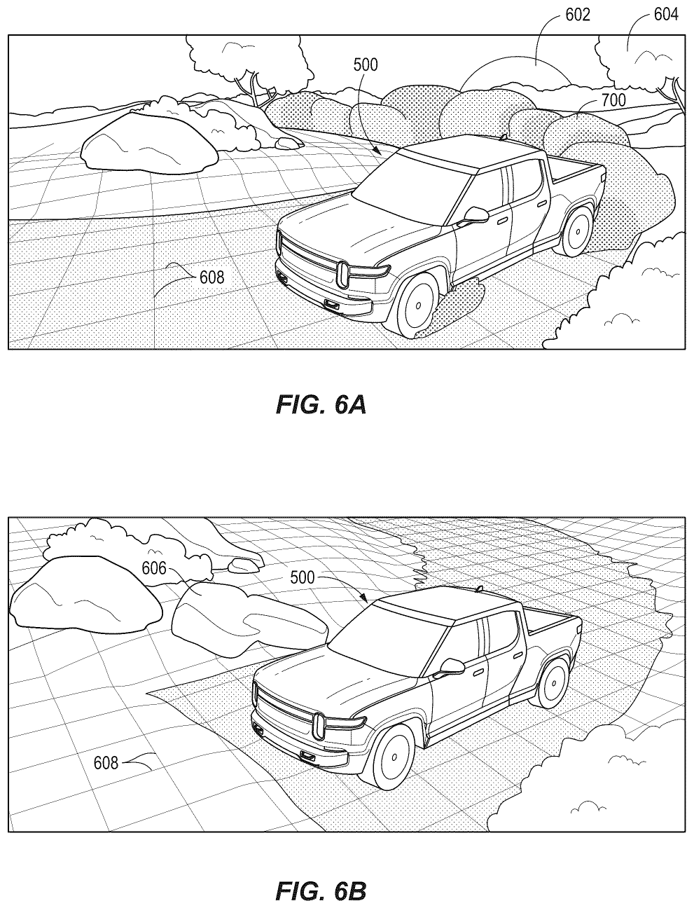

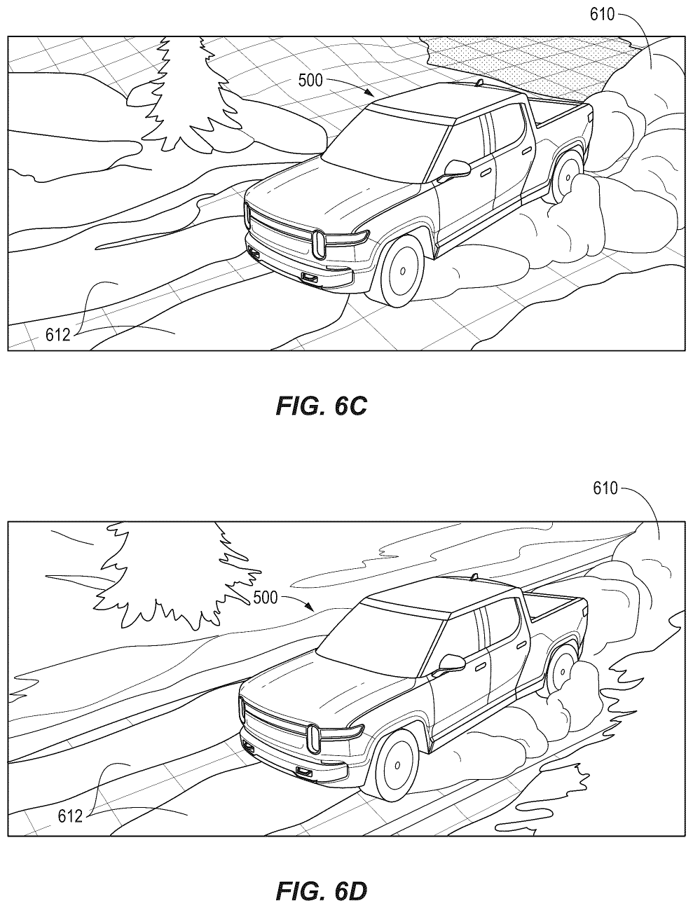

The scene database 312 may include animations 318. The animations 318 may include a transformation over time with respect to location and/or orientation that may be traversed by any of the props 316. The animations 318 may define translation of models of clouds, the sun, the moon, or stars. The animations 318 may define movement of birds, wildlife, or livestock. The animations may define time-varying attributes of a campfire, dust cloud, or other object. The scene database 312 may define particle effects simulating such things as campfires, dust, fireflies, and the like. Animations 318 may include vertex animation textures, such as simulated dust plumes in the drift drive mode and/or snow plumes in the snow drive mode (see FIGS. 6A and 6D). The scene database 312 may define scenes for themed events such as holidays, promotional events as well as easter eggs. The animations 318 may include two-dimensional (2D) animated elements that are rendered within the context of a three-dimensional (3D) scene, such as stability splines. For example, such 2D animated elements may be used to represent different drive modes and transitions between drive modes.

The animations 318 may include camera animations and camera transitions between scenes, such as using a simulated spring arm camera configuration. Properties such as spring arm length, spring arm rotation, camera position, camera rotation and camera field of view (FOV) may be synchronously animated.

Any of the animations 318 described herein, including animations of a camera, landscape, props, or model of the vehicle 100 may be implemented as synchronized animations that are deterministic and interruptible. As used herein “deterministic” may mean that at X % (X is a number between 0 and 100) of a transition between scene A and scene B, the same result will always be achieved. One can therefore jump directly to any time within the transition animation at any time.

The animations 318 may further define transformations performed with respect to the model of the vehicle 100, such as opening and closing of a door, liftgate, tailgate, bedcover, charge port cover, gear tunnel cover, or the like. Animations may define transformation of the vehicle 100 such as a change in ride height, leveling of the vehicle, change in tire pressure, or another attribute of the vehicle 100.

The animations 318 may further define transitions between different landscapes 314. For example, the animations 318 may simulate a model of the vehicle 100 driving between different landscapes 314. The animations 318 may define transitions between different environments: from rainy to sunny weather, from night to day, from day to night, etc. The animations for transitions between different landscapes and/or props may be implemented as vertex deformation shaders in a way that keeps the animations of transitions in sync and deterministic.

The scene configurator 302 processes some or all of the inputs shown in FIG. 3 and outputs a scene, such as a three-dimensional scene. For example, the scene may include the model of the vehicle 100 that has been transformed to conform to the vehicle exterior state. Likewise, the scene may include a series of scenes, or a scene and transformations thereof, implementing an animation. For example, an animation showing transformation of the vehicle 100 to the state indicated by the vehicle exterior state. The scene configurator 302 may implement a system to ensure that the wheels of the model of the vehicle 100 are always in contact with the ground throughout the different scenes and through the animation transitions. Maintaining contact between the wheels of the model of the vehicle and the ground of a scene may be achieved through a combination of authored wheel position and “inverse kinematics” to adjust the wheels to the ground. This approach is able to accommodate a variety of possible wheel diameters.

The scene may include a landscape and possibly one or more props 316 corresponding to the vehicle dynamic state. The props 316 may be implemented as 2D elements. The scene may include a landscape and possibly one or more props 316 corresponding to the environmental data 310, e.g., matching the landscape and/or time of day (e.g., day vs. night) indicated in the environmental data 310. For example, a mountain environment with the sun high in the sky in response to the environmental data 310 indicating that the vehicle is located in a mountain environment and that the time of day is around noon. In another example, the scene may represent a forest and include the moon and stars in the sky in response to the environmental data 310 indicating that the vehicle is located in a forest and that the time of day is after sunset. A grid link landscape (e.g., grid lines superimposed on a contoured surface, see FIGS. 7A to 7D) may be used to show the vehicle dynamic state, e.g., to focus on dynamic changes to the vehicle and its environment. The scene configurator 302 may further specify one or more other attributes of the scene 320, such as lighting (e.g., ambient, diffuse, specular), light sources (e.g., light emitted by a representation of the sun, moon, stars, vehicle lights, campfire, or other light source). Lighting may be implemented using baked, precomputed lighting within an art style applied to it. The scene configurator 302 may specify atmospheric effects, such as rain, snow, fog, or the like where the environmental data 310 indicates that it is currently raining, snowing, or foggy at the current location of the vehicle 100. The one or more attributes may include a position of a viewpoint (e.g., virtual camera) from which the scene 320 should be rendered or other attributes of the virtual camera used to render the scene 320. The color of the sky and the resulting coloration on the vehicle and scene props is influenced by the time of day, with respect to the location of the vehicle (lat-long) on earth.

The scene configurator 302 may input the scene 320 to a rendering engine 322. The rendering engine 322 may process the scene 320 and generate an intermediate image 326 that is a rendering of the scene 320 from the viewpoint of the virtual camera and according to lighting, atmospheric effects, and other attributes of the scene 320.

The rendering engine 322 may be any rendering engine known in the art, such as the UNREAL ENGINE. The rendering engine 322 may perform such tasks as vertex shading, rasterization, applying textures, or the like. In some instances, the rendering engine 322 may perform cel shading in which a rendering of a three-dimensional scene is made to appear like a two-dimensional image. Cel shading is a non-photorealistic rendering technique that gives 3D objects a flat, cartoon-like appearance. For example, the rendering engine 322 may provide a discrete number of shadings for a vertex having a specified color and select from among the discrete number of shadings to apply to the vertex based on the amount of light incident on the vertex from the light sources defined for the scene. The rendering engine 322 may implement other approaches to reduce computational requirements, such as using unlit shaders, baked lighting, or other simplifications or optimizations.

The scene configurator 302 may further generate a post-processing configuration 324. The post-processing configuration 324 may specify two-dimensional operations to be performed on the intermediate image 326 to obtain a final image 328. Such operations may include applying a stencil to portions of the image 326 corresponding to particular props represented in the image 326. For example, portions of the image 326 representing light sources such as headlights, a campfire, the moon, stars, etc., may have a bloom effect applied thereto to give the appearance of glowing. In another example, the color of certain features in the image 326 may have color applied thereto to enhance their appearance, such as features representing lane markings, warning labels or symbols, or other markings.

The post-processing configuration 324 may specify one or more anti-aliasing solutions, such as different anti-aliasing solutions customized for specific scenes and specific animations to achieve the desired look for in vehicle viewing. Such anti-aliasing solutions may include temporal anti-aliasing (TAA), fast approximate anti-aliasing (FXAA), conservative morphological anti-aliasing (CMAA), or other anti-aliasing solution.

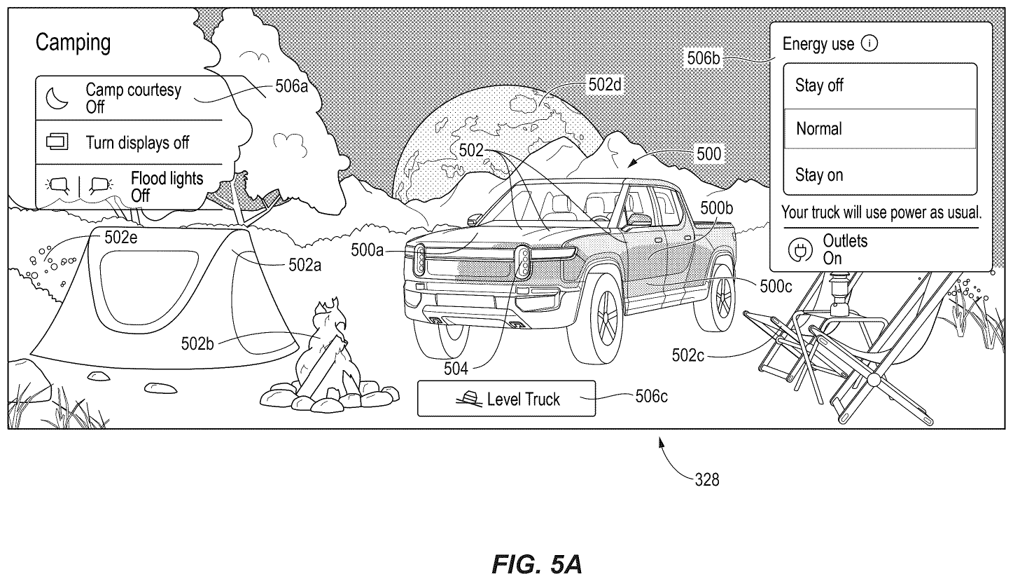

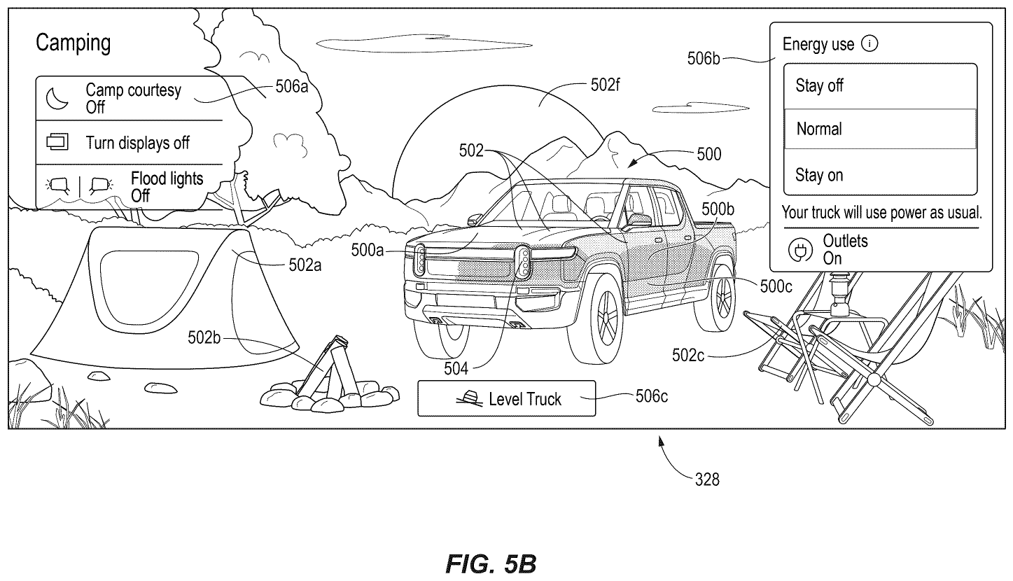

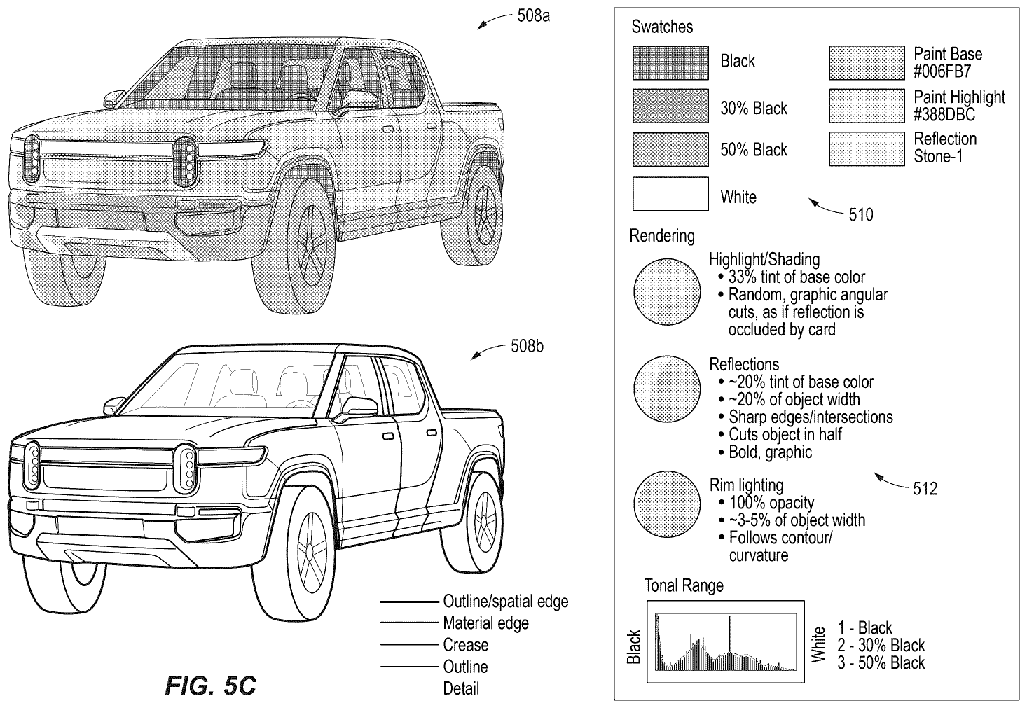

The post-processing configuration 324 may define the application of a post-process alpha mask to make room for overlaying a 2D user interface (UI) that displays vehicle human machine interface (HMI) information. In some embodiments, the post-processing configuration may define application of a custom tone mapping solution to achieve the cel-shaded look described to the art style (see FIG. 5C and corresponding description). The post-processing configuration 324 may further define outline material and fused objects for the rendering of the model of the vehicle 100 as discussed below with respect to FIG. 5C.

The final image 328 may then be output, such as to one or more of the front displays 104. A different final image 328 may be generated for different front displays 104. Where the scene 320 defines an animation, a plurality of final images 328 may be generated, each being a frame of an animated video for a different time step as defined by the scene 320.

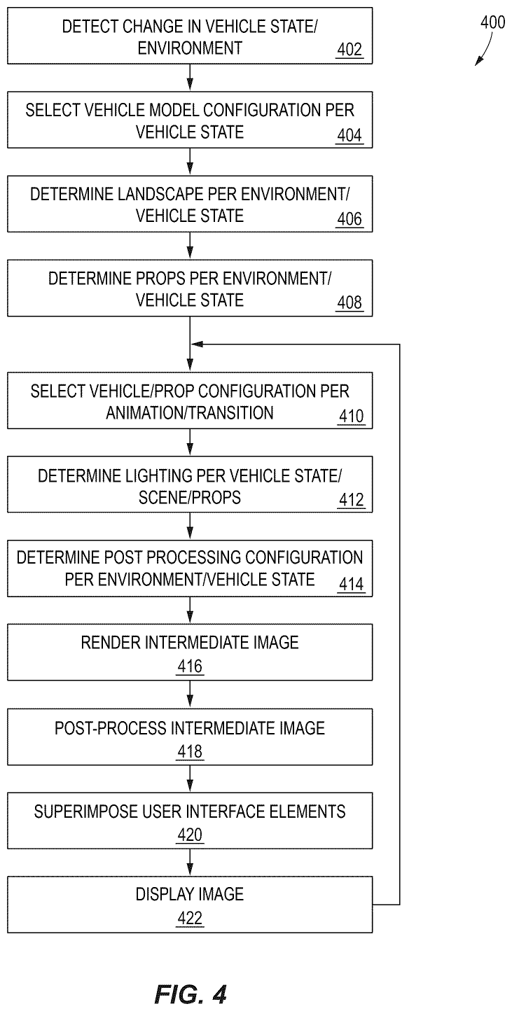

FIG. 4 illustrates a method 400 that may be executed using the system 300. The method 400 may include detecting, at step 402, a change in a state of the vehicle 100, such as a change to the vehicle exterior state 306 or vehicle dynamic state 308. In some embodiments, step 402 may additionally or alternatively include detecting a change to the environmental data 310, e.g., a change in time of day, location, and/or weather. The method 400 may include selecting, at step 404, a vehicle model configuration corresponding to the current vehicle state (e.g., current vehicle exterior state 306 and vehicle dynamic state 308). For example, step 404 may include selecting a model of the vehicle 100 having a configuration matching the vehicle state detected at step 402. For example, the model of the vehicle 100 may have a representation of a door, charge port, lift gate, etc. in a position indicated by the vehicle state; have representations of wheels in a relative position to a representation of the vehicle body corresponding to a ride height indicated by the vehicle state; or have any other attribute corresponding to the vehicle state. Where the vehicle state indicates presence of an accessory, a model of that accessory may be combined with the model of the vehicle 100 in a relative position and orientation of the accessory when in use: a model of a trailer may be placed behind the model of the vehicle, a model of a camper tent may be placed over the bed of the model of the vehicle 100 or at some other position, etc. Note that step 404 may include selecting an animation corresponding to the change to the vehicle state as detected at step 402.

The method 400 may include determining, at step 406, a landscape according to one or both of the vehicle state and the environmental data 310. The landscape may match the environmental data 310: depict a landscape corresponding to the landscape at the vehicle's 100 current location. The landscape may match the vehicle dynamic state 308: depict a landscape for which the current drive mode of the vehicle 100 is configured.

The method 400 may include determining, at step 408, one or more props corresponding to one or both of the environmental data 310 and the vehicle state. For example, the props may correspond to time of day: sun and clouds for daytime and moon and stars for night time. Props determined at step 406 may correspond to the landscape selected at step 406: plants, buildings, wind turbines, birds, wildlife etc. Props may include a dust cloud corresponding to the drive mode: e.g., a cloud of dust corresponding to an off-road mode. Props determined at step 408 may be selected from among a set of possible props mapped to the environmental data 310 and/or the vehicle state in the scene database 312. For example, some props may be fixed and others may be selected randomly from among multiple possibilities defined in the scene database for the environmental data 310 and/or the vehicle state. Step 408 may include selecting an atmospheric effect corresponding to the environmental data 310: snow, rain, fog, etc. corresponding to weather local to the vehicle 100 as indicated in the environmental data 310.

The method 400 may then include generating a single final image 328 or a series of final images 328 implementing an animation based on the vehicle model configuration from step 404, landscape from step 406, and props from step 408.

For example, where an animation is defined for the change in state detected at step 402, the method 400 may include selecting, at step 410, a configuration of the vehicle model and one or more props according to the animation. For example, step 410 may include selecting the relative positions of a component of a vehicle (door, charge port cover, liftgate, vehicle body) or a prop corresponding to a timestep in the animation.

The method 400 may include determining at step 412 lighting, such as lighting corresponding to props (e.g., props such as the sun, moon, stars, or a campfire that emit light), representations of lights in the model of the vehicle 100, or general ambient, diffuse, or specular light sources. Light may be static such that step 412 is performed once for multiple frames or may be variable according to the animation such that step 412 is performed for each timestep of the animation. The lighting determined at step 412 may be determined according to settings associated with the vehicle state, the environmental data 310, or a combination thereof in the scene database 312.

The method 400 may include determining, at step 414, a post-processing configuration 324 for the current time step. Step 414 may include retrieving post-processing parameters, e.g., stencils and corresponding shading, colors, or other effects to apply within stencils, defined for one or more props determined at step 412. The post-processing parameters for a given prop may be selected from among multiple possibilities for the prop, the selected post-processing parameters being associated with the vehicle state, the environmental data 310, or a combination thereof in the scene database 312.

The method 400 may then include rendering, at step 416, the scene including the model of the vehicle 100, landscape, props, lighting, and any atmospheric effects as determined at steps 404, 406, 408, 410, and 412. The result of step 416 is an intermediate image 326. At step 418, the intermediate image may then be post-processed according to the post-processing configuration 324 to obtain the final image 328. Steps 416 and 418 may be performed by the rendering engine 322.

In some embodiments, the final image 328 is used as a background image for a user interface. Accordingly, step 420 may include superimposing one or more user interface elements on the final image. The user interface elements may include text, buttons, menus, or other user interface elements. The user interface elements may relate to the current drive mode of the vehicle or other vehicle mode. The final image 328 with the user interface elements superimposed thereon may then be displayed at step 422, such as on one or more of the front displays 104. One or more of the front displays 104 may be a touch screen through which a user may interact with the user interface elements.

Steps 410-422 may be performed any number of times, such as for multiple timesteps of an animation. Accordingly, the configuration of step 410 may change at step 410 to implement the animation. Repetition of steps 410-422 may end when the animation is complete. The method 400 may repeat from step 402 when another change in the vehicle state or the environmental data 310 is detected.

The method 400 may be executed in real time. In particular, final images 328, and the scenes configured at steps 408, 410, and 412 may be generated according to the method 400 after the vehicle state and/or environmental data 310 is obtained. The method 400 and the system 300 therefore can accommodate many scenarios without requiring images or video for each scenario to be stored, which could require a prohibitively large storage capacity.

FIG. 5A illustrates an example final image 328 with various user interface elements superimposed thereon. The illustrated final image 328 includes a representation 500 of the model of the vehicle 100. The representation may include different areas 500a, 500b, 500c having one of a limited set of possible shadings applied thereto. As indicated above, where cel shading is used, the available shading colors may be limited to a small set, such as 2, 3, 4, or 5 different shading colors. For example, when rendering a cel-shaded image of a vehicle body (e.g., as shown in FIG. 5A), each body panel of the vehicle may be shaded with a small palette of colors (e.g., 2, 3, 4, or 5 colors), such as a lighter shade of the vehicle body color (e.g., blue) for highlights, a darker shade of the vehicle body color for shadows, and a medium shade of the vehicle body color for mid-tones. One or more additional colors having a different hue (e.g., yellow) may also be implemented to represent a specific type of light being emitted by a prop in the three-dimensional scene (e.g., a representation 502b of a model of a campfire) and being reflected by a body panel of the vehicle, such as light from a campfire, light from the sun, light from the moon, etc. Reflections may be rendered using a painted texture system via signed distance field (SDF) textures.

In some embodiments, transitions between reflections defined for different drive modes may be handled in a specific manner when displaying a transition between drive modes. For example, suppose the vehicle is in a snow drive mode and authored reflections from snow are rendered with respect to the mode of the vehicle. During a transition to another drive mode, e.g., drift mode, is the current camera position is less than a given threshold value, the rendering lerps (linear interpolates) to a calculated reflection before settling into a new authored reflection for the drift drive mode. This adds life to the scene transition and ties the vehicle to the environment.

In cel shading, certain edges are highlighted, e.g., with black markings, to help communicate three-dimensional information in an image that appears two-dimensional. In some embodiments, the model of the vehicle 100 from which the representation 500 is generated may include vertices defining such markings. For example, markings 502 in FIG. 5A may be representations of vertices specifically added to the model of the vehicle 100 in order to facilitate cel shading. The markings 502 may each be modeled as an object composed of vertices conforming to an area of the model to be covered by the stripe. The object may conform to the surface of the model and have no thickness. Alternatively, the object may have a non-zero thickness, such as a cylindrical or rectangular tube. The objects may include tapered end portions as well (see, e.g., lines around the frunk in FIGS. 5A to 5C). Accordingly, when the model of the vehicle 100 is rendered, the objects may then be rendered as the markings 502. The objects may be bound to the model of the vehicle 100 such that the objects change orientation with change in orientation of the model of the vehicle 100. The objects may be modified in correspondence with a distance from a location of a virtual camera. For example, the width of the objects that represent the markings 502 may increase with an increase in distance from the location of the virtual camera such that the width of stripes resulting from rendering of the objects remains substantially (e.g., within 15 percent of) the same in rendered images. As used herein “width” refers to width perpendicular to a path defined by a centroid of the object and corresponds to the line weight of lines resulting from rendering of the objects.

The use of objects composed of vertices to represent the markings 502 may therefore facilitate a more consistent rendering of the model of the vehicle 100. The use of objects composed of vertices further enables the control of the appearance of the markings 502 to be performed by managing of the geometry of the objects composed of vertices, which reduces memory requirements (e.g., texture memory usage) and is more computationally efficient as compared to using applying textures (e.g., via texture mapping) to manage rendering of the markings 502. For images displayed in a gauge cluster (e.g., a front screen 104 in front of a driver) some lines may be converted to signed distance field textures to improve render quality (less aliasing). The post-processing configuration 324 may define processes for determining the vehicle outline and combining the depth and scene buffers. An algorithm, such as standard convolution, may be used to perform edge detection.

FIG. 5C illustrates an example rendering 508a of the model of the vehicle 100 as well as a rendering 508b of lines generated from objects associated with the model of the vehicle 100 to facilitate rendering of markings 502. As is apparent, the objects may correspond to outlines of components of the vehicle, edges of components of the vehicle, creases in components of the vehicle, cutlines, and other details. FIG. 5C illustrates color swatches 510 showing the discrete set of colors used to show different levels of illumination of surfaces of the model of the vehicle. FIG. 5C further shows different combinations 512 of colors showing representations of highlights, reflections, and rim lighting.

The final image 328 further includes renderings of various props. For example, the illustrated final image 328 may correspond to a camping mode and include a representation 502a of a model of a tent, a representation 502b of a model of a campfire, a representation 502c of a model of a camp chair, a representation 502d of a model of the moon, and a representation 502e of models of fireflies. Other objects (e.g., trees, mountains, grass, etc.) may be renderings of models of props or be part of the landscape used to render the final image 328.

The final image 328 may be rendered with generalized lighting (e.g., ambient, diffuse, and/or specular lighting) and may be rendered with simulated lighting by light sources, such as the moon (e.g., representation 502d), the campfire (e.g., representation 502b), fireflies (e.g., representation 502c), and/or lights (e.g., representation 504 in FIG. 5A) of the vehicle. As indicated above, representations of props may be subject to post-processing. For example, a representation of an object that emits light may be blurred or otherwise shaded to simulate the emission of light by the representation of the object. For example, the representation 502b of a campfire may be post-processed to add blur. In some embodiments, lighting may be rendered without simulating reflection by using emissive in unlit shaders, which drastically reduces the computational resources required. Additionally or alternatively, lighting may be simulated in a computationally reduced fashion by using shaders to implement painted reflections or the like.

FIG. 5A further illustrates interface elements 506a, 506b, 506c that may be superimposed on the final image 328. For example, the final image 328 may be for a camping mode. User interface elements 506a, 506b, 506c for functions available in the camping mode may therefore be superimposed on the final image 328. For example, interface elements 506a controlling operation of lights 220 of the vehicle 100, user interface elements 506b controlling power usage from the battery 110, and a user interface element 506c for invoking leveling of the vehicle 100 using the suspension 120.

FIG. 5B illustrates an alternative final image 328 such as might be generated for the same camping mode as FIG. 5A. For example, the final image 328 of FIG. 5A may be generated during the night whereas the final image 328 of FIG. 5B may be generated during the day.

As is apparent, the props represented in the final image 328 of FIG. 5B may be changed: the representation 502d of the moon may be replaced with a representation 502f of the sun. The representation 502b of the campfire may be changed to show the campfire extinguished. The lighting used to render the final image 328 of FIG. 5B may be changed to include more intense ambient, diffuse, and/or specular light and possibly account for increased light from a light source corresponding to the representation 502f of the sun. Representations 504 of lights on the vehicle 100 may be shown as turned off.

The representation 500 of the vehicle 100 may remain the same or may vary in response to changes in the vehicle state. Cel shading of the representation 500 of the vehicle with the changed lighting may result in areas 500a, 500b, 500c having different shading corresponding to the more intense light and different angles of incidence of light.

FIGS. 6A, 6B, 6C, and 6D illustrate the transition between scenes, such as in response to changing from one vehicle mode to another (e.g., between drive modes, to and from camping mode, etc.). The transition may be defined in the scene database 312. For example, for each scene, one or more transitions may be defined, e.g., a transition to the scene and a transition from the scene. A transition to the scene may define movement and/or transformation of props to final positions within the scene. Transitions of props into a scene may include movements into a rendered region of a scene, vertical movement down to a surface of the landscape, vertical movement up through a surface of the landscape, growth of an object from nothing to a final size in the scene, and/or other movements or transformations (e.g., up from a surface of the landscape). Transition of props from a scene may include movements out of a rendered region of a scene, vertical movement up and away from a surface of the landscape, vertical movement down through a surface of the landscape, and/or shrinking of an object to nothing (e.g., down toward a surface of the landscape). The transition of a prop into a scene may be the reverse of the transition of the prop into the scene. Accordingly, if a transition to a scene is interrupted, the direction of transitions of props may be reversed from their states at the time of the interruption. Accordingly, any timing of user selection of vehicle modes may be accommodated. For example, a user may select a first drive mode and thereby invoke transition to a first scene. During the transition to the first scene, the user may select a second drive mode invoking transition away from the first scene such that props transition from their current position/size out of the scene and a transition to the second scene is performed. A transition between scenes may also include a transition in the location of a virtual camera, e.g., a gradual transition over several timesteps. A transition between scenes may also include a transition in the orientation of the model of the vehicle 100, e.g., a gradual transition over several timesteps.

As shown in FIGS. 6A and 6B, a transition from a scene rendering for a first drive mode (drift mode in the illustrated example) to a scene rendering for a second drive mode (snow mode in the illustrated example) may be performed in a dynamic way. The transition may be accompanied by transitioning props (old props sinking into the ground, new props rising). For example, the dust cloud 600, sun 602, and tree 604 of FIG. 6A disappears and snow drift 606 appears. Note that a grid 608 may be rendered on the rendering of the terrain to show contours and which may be covered by props as they appear on the scene. Referring to FIGS. 6C and 6D, additional props may rise from the terrain in the scene before the transition is complete, such as a plume 610 of snow and snow drifts 612.

The scene may transition from one edge or corner to an opposite edge or corner. For example, from left to right in the illustrated example. The color of the ground surface may, for example, transition from brown to white moving from left to right along with the transitions described above for the props. The transition may be accompanied by a change in camera position as shown by the different point of view from which the scenes of FIGS. 6A to 6D are rendered. Additional changes, such as changes in the pose of the representation 500 of the vehicle, rotating of the wheels of the representation 500 of the vehicle, or other changes may give the impression of the vehicle moving to new terrain.

One a transition between scene renderings is complete, the first scene rendering may be unloaded, e.g., removed from memory to save resources. However, the scene rendering may remain during the transition in case the transition is reversed partway through.

To facilitate the transitions shown in FIGS. 6A to 6D objects (e.g., props and the representation 500 of the vehicle 10) may be kept as static meshes and the animations may be done through vertex deformation in a shader. In some embodiments, all objects in a scene for a drive mode are given a drive mode index, which guides performance of the transition, e.g., which objects should be transitioning in or out of a scene may be readily determined based on the drive modes that are being transitioned between and the indexes of the objects.

During transitions, props may be processed using additional shader logic so that they can shrink or grow during transitions. Background scenery (“cards”), such as mountains, sun, clouds, etc. may be translated into and out of a scene, while background props (sun, clouds, etc.) can translate vertically. The grid 608 may help provide continuity during transitions and may be rolled into a scene during transitions over a ground surface. Likewise, a boundary between the terrains of the old and new scenes may be rendered as a mix of old and new terrain colors (e.g., a brown of the drift mode scene and the white of the snow mode scene). The grid 608 and terrain that is a mix of old and new terrain colors provides a gradient as it transitions through the scene that helps hide any gaps in the terrain caused by the vertex deformation.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle comprising:
a chassis;
a vehicle body mounted to the chassis;
a display device within the vehicle body; and
a control system coupled to the chassis and the display device, the control system configured to:
detect a change to at least one of the chassis or the vehicle body;
generate a three-dimensional scene including a representation of a three-dimensional model the vehicle, the three-dimensional scene corresponding to the change;
render the three-dimensional scene to obtain an image; and
output the image on the display device.

2. The vehicle of claim 1, wherein the change is a change from a first drive mode of a plurality of drive modes to a second drive mode of the plurality of drive modes, each drive mode of the plurality of drive modes having a set of attributes of the chassis.

3. The vehicle of claim 2, wherein the control system is configured to generate the three-dimensional scene by adding one or more props to the three-dimensional scene, the one or more props corresponding to the second drive mode.

4. The vehicle of claim 3, wherein the control system is configured generate the three-dimensional scene by animating the one or more props.

5. The vehicle of claim 2, wherein the set of attributes of the chassis include attributes of a suspension of the chassis.

6. The vehicle of claim 5, wherein the attributes of the suspension include at least one of ride height, suspension stiffness, or suspension damping.

7. The vehicle of claim 2, wherein the set of attributes of the chassis include behavior of drive units of the chassis.

8. The vehicle of claim 7, wherein the behavior of the drive units include at least one of an accelerator pedal response, brake pedal response, or a regenerative braking behavior.

9. The vehicle of claim 2, wherein the plurality of drive modes include at least one off-road mode and at least one conserve mode.

10. The vehicle of claim 1, wherein the change is a change to the vehicle body and includes at least one a change to a state of a door or a change to a state of a port cover.

11. The vehicle of claim 10, wherein the control system is configured to generate the three-dimensional scene including the representation of the three-dimensional model of the vehicle with the three-dimensional model being modified according to the change to the vehicle body.

12. The vehicle of claim 10, wherein the control system is configured to generate the three-dimensional scene including the representation of the three-dimensional model of the vehicle by generating an animation of the three-dimensional model of the vehicle undergoing the change to the vehicle body.

13. The vehicle of claim 1, wherein the control system is configured to render the three-dimensional scene to obtain the image by performing cel shading.

14. The vehicle of claim 13, wherein the three-dimensional model includes objects superimposed thereon, wherein the control system is configured to perform cel shading by modeling the objects as markings on a representation of the three-dimensional model in the image, each marking of the markings highlighting at least one of an outline, an edge, and a crease in the three-dimensional model.

15. The vehicle of claim 14, wherein the objects each comprise a plurality of vertices.

16. The vehicle of claim 1, wherein the control system is configured to generate the three-dimensional scene by:
detecting one or more attributes of an environment of the vehicle; and
generating the three-dimensional scene according to the environment of the vehicle.

17. The vehicle of claim 16, wherein the one or more attributes of the environment of the vehicle include a type of landscape in which the vehicle is located.

18. The vehicle of claim 16, wherein the one or more attributes of the environment of the vehicle include a time of day.

19. The vehicle of claim 16, wherein the one or more attributes of the environment of the vehicle include weather at a location of the vehicle.

20. A method comprising:
detecting, by a control system of a vehicle, a change to at least one of a chassis and a vehicle body of the vehicle; and
in response to detecting the change to at the at least one of the chassis and the vehicle, performing, by the control system:
generating a three-dimensional scene including a representation of a three-dimensional model the vehicle, the three-dimensional scene corresponding to the change;
rendering the three-dimensional scene to obtain an image; and
outputting the image on a display device of the vehicle.
